(19) United States
(12) Patent Application Publication
(10) Pub. No.: US 2004/0087739 A1
(43) Pub. Date: May 6, 2004

(54) Monolithic thermoplastic ether polyurethane having high water vapor transmission

(76) Inventor: Kemal Onder, Brecksville, OH (US)

Correspondence Address: NOVEON IP HOLDINGS CORP., 9911 BRECKSVILLE ROAD, CLEVELAND, OH, 44141-3247, US

(21) Appl. No.: 10/283,528

(22) Filed: Oct. 30, 2002

(51) Int. Cl. C08F 283/04

(52) U.S. Cl. 525/453

(57) ABSTRACT

A thermoplastic polyurethane comprising a tetrahydrofuran based polyether diol intermediate chain extended with selective types of diols has good water vapor transmission but is resistant to liquid water through put, has good dimensional stability, good softness and elasticity, good tensile set and is non blocking. The thermoplastic polyurethane can be made by either a one shot process as in an extruder or by a prepolymer route and can be formed into a monolithic sheet or film for such uses as a roofing membrane, house wrapping, tubing, fiber, wound dressing, and the like.

### FIELD OF INVENTION

The present invention relates to a polyether thermoplastic polyurethane extrudable at high speeds into sheets or films having good water vapor transmission but is resistant to liquid water penetration. The thermoplastic polyurethane displays a unique combination of properties such as softness, elasticity, crystallinity, and good dimensional stability.

### BACKGROUND OF THE INVENTION

Heretofore, various polymers having micropores formed therein have been used as moisture vapor transmitting membranes. Such polymers are alleged as being resistant to liquid water throughput but permit water vapor to pass therethrough. These micropore structures are generally not suitable for wraps because they tend to leak liquid water.

European patent application 708,212 A1 relates to an underlayment, particularly for inclined, heat-insulated roofs with a nonwoven fabric layer that is permeable to water vapor, but resistant to liquid water; and to a reinforcing layer that is arranged on and bonded to the fabric layer and is also permeable to water vapor, but impermeable to liquid water.

### SUMMARY OF THE INVENTION

The thermoplastic polyurethane of the present invention is preferably derived from a tetrahydrofuran polyether intermediate reacted with a diisocyanate and low amounts of selective chain extenders to form a non-perforated, solid, crystalline sheet or film. In addition to high water vapor transmission but good resistance to liquid water throughput, the polyurethane has several favorable properties such as high speed extrusion, low Shore A hardness (softness), good elasticity (Tg of minus −30° C. or less), suitable crystallinity for rapid extrusion and non-blocking, good dimensional stability in water at 24 hours, and the like.

### DETAILED DESCRIPTION OF THE DRAWINGS

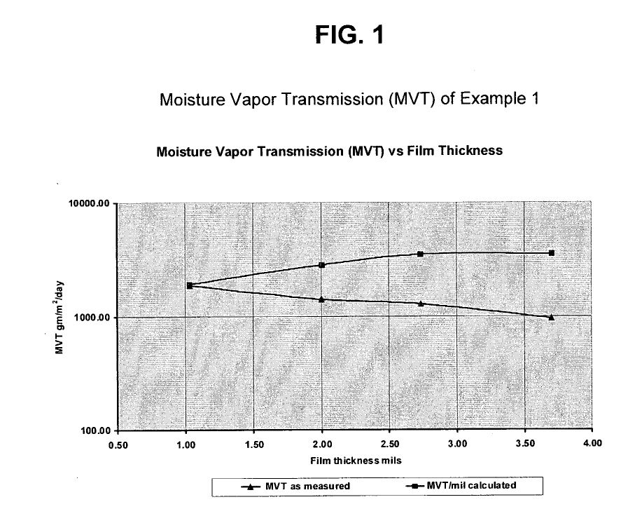

FIG. 1 is a graph showing the moisture vapor transmission of the composition of Example 1;

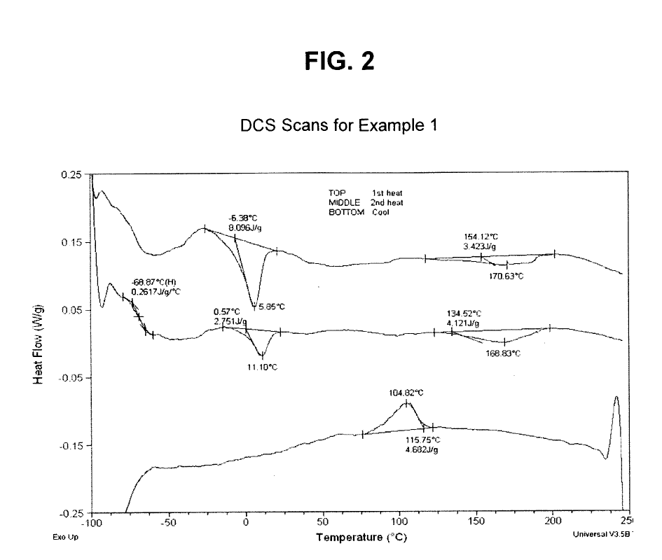

FIG. 2 is a graph showing DCS scans of the composition of Example 1;

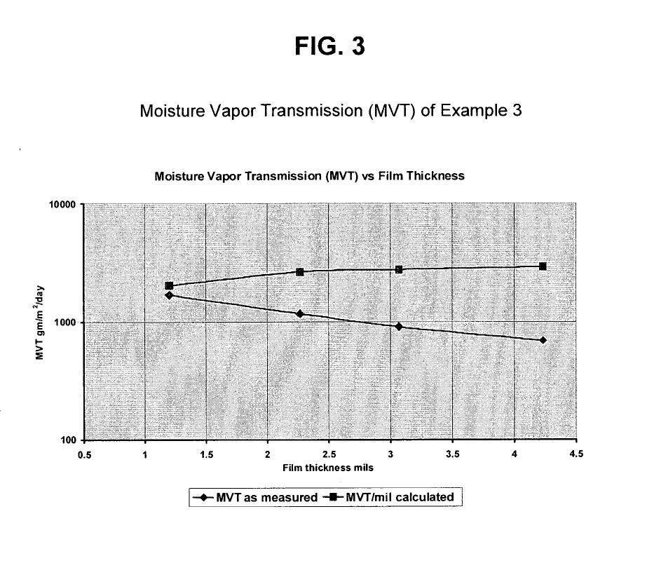

FIG. 3 is a graph showing the moisture vapor transmission of the composition of Example 3;

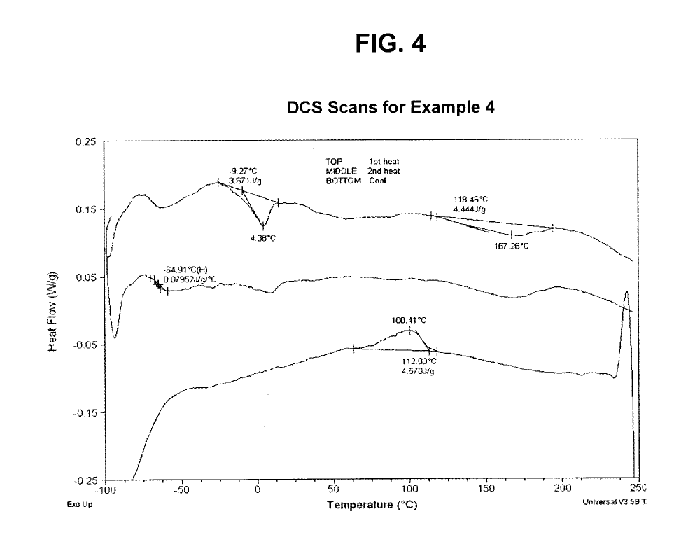

FIG. 4 is a graph showing DCS scans of the composition of Example 4;

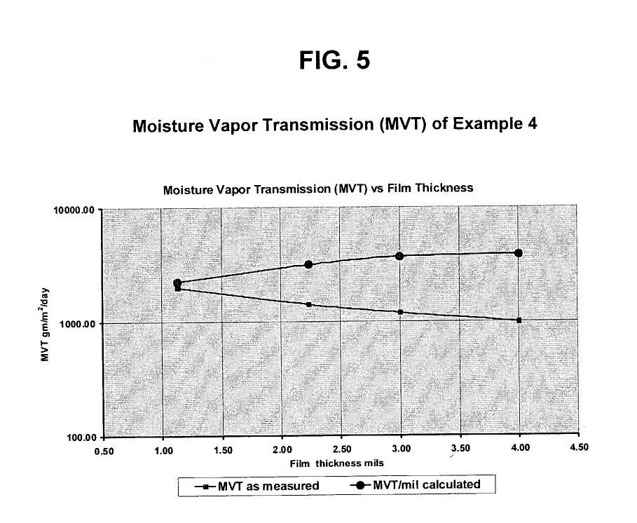

FIG. 5 is a graph showing the moisture vapor transmission of the composition of Example 4; and

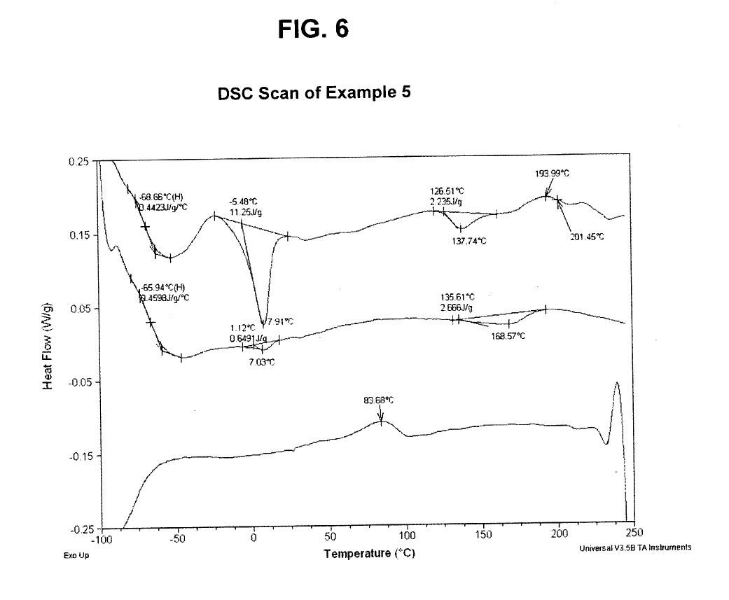

FIG. 6 is a graph showing DCS scans of the composition of Example 5.

### DETAILED DESCRIPTION

The thermoplastic polyurethanes having a unique combination of properties contain a polyether intermediate derived from tetrahydrofuran monomers so that tetramethylene oxide repeat units are present in the intermediate which also has terminal hydroxyl groups. Optionally, selective types of other alkylene oxide monomers can be utilized in addition to the tetrahydrofuran monomers to form ether copolymers such as propylene oxide or a mixture of propylene oxide with ethylene oxide since other types of monomers generally yield poor dimensional stability. The ether intermediate generally has a number average molecular weight of from about 500 to about 4,000, desirably from about 1,000 to about 2,500, and preferably from about 1,500 to about 2,200 as determined by hydroxyl end groups. The amount of the one or more optional comonomers is generally from about 15 to about 75 and desirably from about 20 to about 30 parts by weight per 100 total parts by weight of the tetrahydrofuran monomers. The amount of the ethylene oxide monomers, when utilized, is generally from about 15% to about 50% and desirably from about 20% to about 30% based upon the total weight of the propylene oxide and ethylene oxide monomers.

The polyether intermediate is one of three main ingredients forming the thermoplastic urethanes of the present invention and the amount thereof is generally from about 60% to about 80%, desirably from about 65% to about 75%, and preferably from about 67% to about 73% by weight based upon the total weight of the polyether intermediate, a polyisocyanate, and a chain extender. The amount of polyisocyanate is generally from about 20% to about 30% and desirably from about 22% to about 28% by weight, and the amount of the chain extender is from 1% to about 10% and desirably from about 2% to about 8% by weight, based upon the total weight of the polyether intermediate, the polyisocyanate, and the chain extender.

The polyisocyanates of the present invention generally have the formula R(NCO)ₙ where n is generally from 2 to 4 with 2 being highly preferred inasmuch as the composition is a thermoplastic. Thus, polyisocyanates having a functionality of 3 or 4 are utilized in very small amounts, for example less than 5% and desirably less than 2% by weight based upon the total weight of all polyisocyanates, inasmuch as they cause crosslinking. R can be aromatic, cycloaliphatic, and aliphatic, or combinations thereof generally having a total of from 2 to about 20 carbon atoms. Examples of suitable aromatic diisocyanates include diphenyl methane-4,4′-diisocyanate (MDI), H₁₂ MDI, m-xylylene diisocyanate (XDI), m-tetramethyl xylylene diisocyanate (TMXDI), phenylene-1,4-diisocyanate (PPDI), 1,5-naphthalene diisocyanate (NDI), and diphenylmethane-3,3′-dimethoxy-4,4′-diisocyanate (TODI). Examples of suitable aliphatic diisocyanates include isophorone diisocyanate (IPDI), 1,4-cyclohexyl diisocyanate (CHDI), hexamethylene diisocyanate (HDI), 1,6-diisocyanato-2,2,4,4-tetramethyl hexane (TMDI), 1,10-decane diisocyanate, and trans-dicyclohexylmethane diisocyanate (HMDI). A highly preferred diisocyanate is MDI containing less than about 3% by weight of ortho-para (2,4) isomer.

Generally any conventional catalyst can be utilized to react the diisocyanate with the polyether intermediate or the chain extender and the same is well known to the art and to the literature. Examples of suitable catalysts include the various alkyl ethers or alkyl thiol ethers of bismuth or tin wherein the alkyl portion has from 1 to about 20 carbon atoms with specific examples including bismuth octoate, bismuth laurate, and the like. Preferred catalysts include the various tin catalysts such as stannous octoate, dibutyltin dioctoate, dibutyltin dilaurate, and the like. The amount of such catalyst is generally small such as from about 20 to about 200 parts per million based upon the total weight of the polyurethane forming monomers.

In addition to the selective types of polyether intermediates utilized, it is an important aspect of the present invention to use selective types of chain extenders in order to achieve the unique combination of physical properties of the thermoplastic polyurethanes of the present invention. While butane diol is preferred, ethylene glycol, hexane diol, dipropylene diol, ethoxylated hydroquionone and 1,4-cyclohexylydiene diol can also be utilized. Low amounts of the chain extender are utilized in order to keep the number of hard segments of the polyurethane low and thus to produce a soft, elastic, resilient, but high moisture vapor transmissible polyurethane.

Thermoplastic polyurethanes of the present invention are preferably made via a “one shot” process wherein all the components are added together simultaneously or substantially simultaneously to a heated extruder and reacted to form the polyurethane. The equivalent ratio of the diisocyanate to the total equivalents of the hydroxyl terminated polyether intermediate and the diol chain extender is generally from about 0.95 to about 1.10, desirably from about 0.98 to about 1.05, and preferably from about 0.99 to about 1.03. The equivalent ratio of the hydroxyl terminated polyether to the hydroxyl terminated chain extender is generally from 0.5 to about 1.5 and preferably from about 0.70 to about 1. Reaction temperatures utilizing urethane catalyst are generally from about 175° C. to about 245° C. and preferably from about 180° C. to about 220° C. The number average molecular weight of the thermoplastic polyurethane is generally from about 10,000 to about 150,000 and desirably from about 50,000 to about 100,000 as measured by GPC relative to polystyrene standards.

The thermoplastic polyurethanes can also be prepared utilizing a prepolymer process. In the prepolymer route, the hydroxyl terminated tetramethylene oxide based polyether intermediate is reacted with generally an equivalent excess of one or more polyisocyanates to form a prepolymer solution having free or unreacted polyisocyanate therein. Reaction is generally carried out at temperatures of from about 80° C. to about 220° C. and preferably from about 150° C. to about 200° C. in the presence of a suitable urethane catalyst. Subsequently, a selective type of chain extender as noted above is added in an equivalent amount generally equal to the isocyanate end groups as well as to any free or unreacted diisocyanate compounds. The overall equivalent ratio of the total diisocyanate to the total equivalent of the hydroxyl terminated polyether and the chain extender is thus from about 0.95 to about 1.10, desirably from about 0.98 to about 1.05 and preferably from about 0.99 to about 1.03. The equivalent ratio of the hydroxyl terminated polyether to the chain extender is generally from about 0.5 to about 1.5 and desirably from about 0.7 to about 1. The chain extension reaction temperature is generally from about 180° C. to about 250° C. with from about 200° C. to about 240° C. being preferred. Typically the prepolymer route can be carried out in any conventional device with an extruder being preferred. Thus, the polyether intermediate is reacted with an equivalent excess of a diisocyanate in a first portion of the extruder to form a prepolymer solution and subsequently the chain extender is added at a downstream portion and reacted with the prepolymer solution. Any conventional extruder can be utilized, with extruders equipped with barrier screws having a length to diameter ratio of at least 20 and preferably at least 25.

Useful additives can be utilized in suitable amounts and include opacifying pigments, colorants, mineral fillers, stabilizers, lubricants, UV absorbers, processing aids, and other additives as desired. Useful opacifying pigments include titanium dioxide, zinc oxide, and titanate yellow, while useful tinting pigments include carbon black, yellow oxides, brown oxides, raw and burnt sienna or umber, chromium oxide green, cadmium pigments, chromium pigments, and other mixed metal oxide and organic pigments. Useful fillers include diatomaceous earth (superfloss) clay, silica, talc, mica, wallostonite, barium sulfate, and calcium carbonate. If desired, useful stabilizers such as antioxidants can be used and include phenolic antioxidants, while useful photostabilizers include organic phosphates, and organotin thiolates (mercaptides). Useful lubricants include metal stearates, paraffin oils and amide waxes. Useful UV absorbers include 2-(2′-hydroxyphenol)benzotriazoles and 2-hydroxybenzophenones.

Plasticizer additives can also be utilized advantageously to reduce hardness without affecting properties.

The thermoplastic ether polyurethanes of the present invention made utilizing selective monomers as set forth hereinabove have unexpectedly been found to yield a unique combination of properties which render the polyurethane suitable for numerous end uses set forth herein below. The thermoplastic polyurethane has a high crystalinity such as from about 3 J/g to about 10 J/g and desirably from about 4 J/g to about 8 J/g as measured by a differential scanning calorimeter. Such crystallinity permits extrusion of films and sheets at high speeds such as at least 25 meters per minute, desirably from about 30 to about 60 meters per minute and preferably from about 40 to about 50 meters per minute on a 120 millimeter extruder fitted with a 120 centimeter slit die set at a gap of 4 mils. Such extrusion rates are faster than conventional polyurethanes of similar hardness and lower crystallinity. The conventional, prior art products with lower crystallinity contain high level of lubricants and antiblocking agents which reduce the moisture vapor transmission rates. Crystallinity also imparts good non-blocking properties so the sheets or films can be rolled upon itself without sticking. Yet, the thermoplastic ether polyurethane is generally soft and elastic.

The ASTM D-2240 Shore A hardness is generally about 80 or less, desirably from about 68 to about 78, and preferably from about 70 to about 75. The polyurethanes of the present invention are very elastic due in part to the low Tg thereof which is generally less than about minus 30° C., desirably less than about minus 40° C., and preferably from about minus 40° C. to about minus 75° C. as measured by differential scanning calorimeter, 10° C./min temperature program. The resilience or elasticity is somewhat similar to rubber in that the polymer can be elongated generally from about 50% to about 300% or 500% and desirably from about 100% to about 200% with ready retraction to its original length.

Another desirable attribute of the thermoplastic polyurethanes of the present invention is that they have excellent dimensional stability of less than 10%, desirably less than 5% and preferably less than about 3% or about 1.5% weight gain after being immersed in water for 24 hours, ASTM D-471-98.

A notable property of the thermoplastic polyurethane is its excellent water vapor transmission as measured by a Mocon Permatran-W model instrument at a thickness of 1 to 4 mils, (25 to 100 microns) at 38° C. and 100% relative humidity which is at least 1,500, desirably from about 1,500 to about 2,500, and preferably from about 1,700 to about 2,000 grams per square meter per 24 hours at atmospheric pressure. The upright cup moisture vapor transmission at a 1 mil thickness at 23° C. and 50% relative humidity and atmospheric pressure is at least 200, desirably from about 250 to about 450 and preferably from about 275 to about 350 grams per square meter per 24 hours, ASTM E-96.

The mechanical properties of the thermoplastic polyurethane are good in that tensile strengths according to ASTM D-412/D-638 is generally at least about 20 or 30, and preferably from about 35 to about 60 MPa. Tensile set at 200% elongation according to ASTM D-412 is generally less than 15%, desirably less than 10%, and preferably less than about 8%.

Inasmuch as the thermoplastic elastomer when sheeted or formed into film, cast or blown films, etc. is a solid, that is a monolithic barrier free of any perforations, it can be used in any application where high water vapor transmission is desired such as building wrap as for a house, a roofing membrane as in roofing material, as a wound dressing layer for application to a person or animal, for waterproof textiles, and the like. Other applications include tubing for pneumatics or peristaltic pumps, elastic fibers as for Spandex® applications, gaskets, hose jacketing, and the like. Molded articles can also be made such as shoe straps, overmolding over rigid plastics and metals for soft touch handles and covers. Further, laminates of the thermoplastic ether polyurethane elastomers of the present invention can be made wherein the backing layer can be woven or non-woven polyester, polypropylene, paper, polyvinyl chloride, nylon, and the like.

Since the various article, layers, sheets, films, etc, formed from the polyurethanes of the invention are solid, they are substantially free of pin holes, perforations and the like. In other words, they contain a perforated area of less than 1%, less than 0.5%, 0.01%, or 0.005%. To test the presence of pin holes membranes were attached to frames set at 45° angle and soaked with shower heads placed above the frames to simulate rain for at least a few hours. The presence of pin holes show up as wet circles on the reverse side of membranes. They are counted per unit area of (m²) membrane and membranes showing pinholes (measured as leak spots) in number above 0.001/m² are not used.

The present invention will be better understood by reference to the following examples which serve to illustrate, but not to limit the invention.

### EXAMPLES

### Example 1

(One Shot)

Polyether polyol PTMEG of molecular weight 2000 Daltons is charged into a heated (90° C.) and agitated tank blended with based on 100 points by weight of the final polymer weight, with 0.3% by weight antioxidant and 0.3% by weight uv stabilizer. A second preheated tank was charged with the chain extender, 1,4-butanediol and kept at 50° C. A third preheated agitated tank contained 4,4′-methylenebisphenylisocyanate (MDI). The ingredients of three tanks were metered accurately into throat of a 40 mm co-rotating twin-screw extruder reactor made by Werner & Pfleiderer Corp., Ramsay, N.J. The extruder had 11 barrel sections which were heated between 190° C. to 205° C. The end of the extruder was coupled to an under-water pelletizer after a six hole die equipped with screen packs. The following formulation was run continuously by metering 25.07 pts of MDI, 5.82 pts of 1,-4-butanediol and 68.5 pts of polyol (PTMEG). Extruder throughput was adjusted to 150 lbs/hr while from a separate small tank 50 ppm (based on polymer) of stannous octoate catalyst was injected into polyol stream. The product was underwater pelletized and collected in a heated silo at 105° C. to dry the product for three hours. The product produced in this way was extruded into 2 mils thick void free films with a single screw extruder fitted with a flat film die. Extruder speed can be varied from 30 to 70 without causing any tackiness and very little rise in melt temperature. The properties of the film was measured and listed in Table 1 and the moisture vapor transmission and the DCS scans are set forth respectively in FIGS. 1 and 2.

TABLE 1
Film Properties of Polymer of Example 1:

| | | Typical Values | |
|---|---|---|---|
| | | SI | English |
| Typical Properties | Test Method | Units | Units |
| PHYSICAL | | | |
| Specific Gravity | ASTM D-792 | 1.13 | 1.13 |
| Shore Hardness | ASTM D-2240 | 72 A | 72 A |
| (after 5 sec) | | | |
| MECHANICAL | | | |
| Tensile Strength | ASTM D-412/D-638 | 52.4 MPa | 7600 psi |
| Stress @ | ASTM D-412/D-638 | | |
| 100% Elongation | | 5.7 MPa | 820 psi |
| 300% Elongation | | 10.2 MPa | 1480 psi |
| Ultimate | ASTM D-412/D-638 | 660% | 660% |
| Elongation | | | |
| Tensile Set @ | ASTM D-412 | 6% | 6% |
| 200% Elongation | | | |
| Tear Strength | ASTM D-624, Die C | 67.6 kN/m | 386 lb/in |
| Split Tear | ASTM D-470 | 17.2 kN/m | 98 lb/in |
| Resistance | | | |
| THERMAL | | | |
| Glass Transition | DSC | | |
| Temperature | | | |
| Pellets | | −67° C. | −89° F. |
| Film (1.2 mil) | | −69° C. | −92° F. |
| Melt Temperature | | | |
| Pellets | | 167° C. | 333° F. |
| Film (1.2 mil) | | 170° C. | 338° F. |
| Crystallization | | | |
| Temperature | | | |
| Pellets | | 97° C. | 207° F. |
| Film (1.2 mil) | | 90° C. | 194° F. |
| Kofler Melt Point | Kofler | 155° C. | 311° F. |
| OTHER | | | |
| RELEVANT | | | |
| DATA | | | |
| Moisture Vapor | | | |
| Transmission | | | |
| Mocon (38° C./ | ASTM D 6701 | 1880 g/m² · | 1880 g/m² · |
| 100% RH) | | 24 h | 24 h |
| Upright Cup | ASTM E-96 | 310 g/m² · | 310 g/m² · |
| (23° C./50% RH) | | 24 h | 24 h |

### Example 2

(One Shot)

Polyether polyol PTMEG of molecular weight 2000 Daltons and dipropylene glycol (DPG) chain extender are charged into a heated (90° C.) and agitated tank in at a ratio of 68.04:1.34 by weight and blended based on the final polymer weight, with 0.3% by weight antioxidant and 0.3% by weight uv stabilizer. A second preheated tank was charged with the chain extender 1,4-butanediol and kept at 50° C. A third preheated agitated tank contained 4,4′-methylenebisphenylisocyanate (MDI). The ingredients of three tanks were metered accurately into throat of a 40 mm co-rotating twin-screw extruder reactor made by Werner & Pfleiderer Corp., Ramsay, N.J. The extruder had 11 barrel sections which were heated between 190° C. to 205° C. The end of the extruder was coupled to an under-water pelletizer after a six hole die equipped with screen packs. The following formulation was run continuously by metering 25.07 pts of MDI, 4.94 pts of 1,-4-butanediol and 69.4 pts of polyol (PTMEG)/(DPG) mixture from the first tank. PTMEG/DPG blend and BDO was combined and passed through a static mixer forming a single stream which was fed with the MDI stream into a heated pre-reactor which discharged the partially reacted mixture continuously into the extruder throat. Extruder throughput was adjusted to 150 lbs/hr while from a separate small tank 50 ppm (based on polymer) of stannous octoate catalyst was injected into polyol stream. The product was underwater pelletized and collected in a heated silo at 105° C. to dry the product for three hours. Melt flow index (MFI) of the pelletized product was measured to be 15.6 at 200° C./3800 gm. The product was extruded into 2 mils thick void free films with a single screw extruder fitted with a flat film die. Extruder speed can be varied from 30 to 70 RPM without causing any tackiness and very little rise in melt temperature.

### Example 3

(One Shot)

Polyether polyol PTMEG of molecular weight 1450 Daltons is charged into a heated (90° C.) and agitated tank blended, based on the final polymer weight, with 0.3% by weight antioxidant and 0.3% by weight uv stabilizer. A second preheated tank was charged with the chain extender 1,4-butanediol and kept at 50° C. A third preheated tank agitated tank contained 4,4′-methylene bisphenyl isocyanate (MDI). The ingredients of the three tanks were metered accurately into throat of a 40 mm corotating twin-screw extruder reactor made by Werner & Pfleiderer Corp., Ramsay, N.J. The extruder had 11 barrel sections which were heated between 190° C. to 205° C. The end of the extruder was coupled to an under-water pelletizer after a six hole die equipped with screen packs. The following formulation was run continuously by metering 25.07 pts of MDI, 4.52 pts of 1,-4-butanediol and 69.8 pts of polyol (PTMEG). PTMEG and BDO was combined and passed through a static mixer forming a single stream which was fed with the MDI stream into a heated pre-reactor which discharged the partially reacted mixture continuously into the extruder throat. Extruder throughput was adjusted to 150 lbs/hr while from a separate small tank 50 ppm (based on polymer) of stannous octoate catalyst was injected into the polyol stream. The product was underwater pelletized and collected in a heated silo at 105° C. to dry the product for three hours. Melt flow index (MFI) of the palletized product was measured to be 6.2 at 200° C./3800 gm. The product produced was extruded into 1 to 4 mils thick void free films with a single screw extruder fitted with a flat film die. Extruder speed can be varied from 30 to 70 without causing any tackiness and very little rise in melt temperature. Moisture vapor transmission rates (MVT) are plotted in FIG. 3 and extrapolated to a value of 2800 gms.m²/day measured with the Mocon Permatran-W Model instrument made by Mocon Company, Minneapolis, Minn. at 38° C. and 100% relative humidity.

### Example 4

(One Shot)

Polyether polyol PTMEG of molecular weight 2000 Daltons is charged into a heated (90° C.) and agitated tank blended based on the final polymer weight, with 0.3% by weight antioxidant and 0.3% by weight uv stabilizer. A second preheated tank was charged with the chain extender 1,4-butanediol and kept at 50° C. A third preheated agitated tank contained 4,4′-methylenebisphenylisocyanate (MDI). The ingredients of three tanks were metered accurately into throat of a 40 mm co-rotating twin-screw extruder reactor made by Werner & Pfleiderer Corp., Ramsay, N.J. The extruder had 11 barrel sections which were heated between 190° C. to 205° C. The end of the extruder was coupled to an under-water pelletizer after a six hole die equipped with screen packs. The following formulation was run continuously by metering 25.07 pts of MDI, 4.52 pts of 1,-4-butanediol and 69.8 pts of polyol (PTMEG). PTMEG and BDO was combined and passed through a static mixer forming a single stream which was fed with the MDI stream into a heated pre-reactor which discharged the partially reacted mixture continuously into the extruder throat. Extruder throughput was adjusted to 150 lbs/hr while from a separate small tank 50 ppm (based on polymer) of stannous octoate catalyst was injected into polyol stream. 2% based on the polymer of diatomecous earth (superfloss) was also introduced into the extruder at barrel section 2 as a non blocking filler. The product was underwater pelletized and collected in a heated silo at 105° C. to dry the product for three hours. Melt flow index (MFI) of the pelletized product was measured to be 6.2 at 200° C./3800 gm. The product produced was extruded into 1 to 4 mils thick void free films with a single screw extruder fitted with a flat film die. Extruder speed can be varied from 30 to 70 without causing any tackiness and very little rise in melt temperature. The properties of the film was measured and listed in Table 2 and the extrusion outputs are set forth in Tables 3 and 4. DCS scans are set forth in FIG. 4 and moisture vapor transmission rates (MVT) is plotted in FIG. 5 and extrapolates to a value of 3200 gms.m²/day measured with the Mocon Permatran-W Model instrument made by Mocon Company, Minneapolis, Minn. at 38° C. and 100% relative humidity.

TABLE 2
Properties of Product of example 4

| | | Typical Values | |
|---|---|---|---|
| | | SI | English |
| Typical Properties | Test Method | Unit | Units |
| PHYSICAL | | | |
| Specific Gravity | ASTM D-792 | 1.08 | 1.08 |
| Shore Hardness | ASTM D-2240 | 72 A | 72 A |
| (after 5 sec) | | | |
| MECHANICAL | | | |
| Tensile Strength | ASTM D-412/D-638 | 52.4 MPa | 7600 psi |
| Stress @ | ASTM D-412/D-638 | | |
| 100% Elongation | | 5.7 MPa | 820 psi |
| 300% Elongation | | 10.2 MPa | 1480 psi |
| Ultimate | ASTM D-412/D-638 | 660% | 660% |
| Elongation | | | |
| Tensile Set @ | ASTM D-412 | 6% | 6% |
| 200% Elongation | | | |
| Tear Strength | ASTM D-624, Die C | 67.6 kN/m | 386 lb/in |
| Split Tear | ASTM D-470 | 17.2 kN/m | 98 lb/in |
| Resistance | | | |
| THERMAL | | | |
| Glass Transition | DSC | | |
| Temperature | | | |
| Pellets | | −67° C. | −89° F. |
| Film (1.2 mil) | | −69° C. | −92°0 F. |
| Melt Temperature | | | |
| Pellets | | 167° C. | 333° F. |
| Film (1.2 mil) | | 170° C. | 338° F. |
| Crystallization | | | |
| Temperature | | | |
| Pellets | | 97° C. | 207° F. |
| Film (1.2 mil) | | 90° C. | 194° F. |
| Kofler Melt Point | Kofler | 155° C. | 311° F. |
| Comrression Set | | | |
| @ 23 ° C. | | 20% | 20% |
| @ 70 ° C. | | 29% | 29% |
| OTHER | | | |
| RELEVANT | | | |
| DATA | | | |
| Moisture Vapor | | | |
| Transmission | | | |
| Mocon (38° C./ | ASTM D 6701 | 1880 g/m² · | 1880 g/m² · |
| 100% RH) | | 24 h | 24 h |
| Upright Cup | ASTM E-96 | 310 g/m² · | 310 g/m² · |
| (23° C./50% RH) | | 24 h | 24 h |
| DIMENSIONAL | | | |
| STABILITY | | | |
| Immersion | ASTM D471-98 | | |
| Results in Water | Volume Change % | 0.96 | 0.96 |
| Time 24 hrs | Mass Change % | 1.03 | 1.03 |

Extrusion Output study on polymer of Example 4

TABLE 3
1½″ Akron Extruder 32:1 barrier screw Saxton Mixer, 12″ wide die
Temperature settings 355° F. 365° F. 375° F., die 375° F.

| | speed | pressure | current | melt T | rate (lb/h) |
|---|---|---|---|---|---|
| product | rpm | psi | amps | ° F. | (ave of 3) |
| Polymer of Example 4 | 30 | 1900 | 8 | 397 | 16.2 |
| | 50 | 1800 | 9 | 416 | 27.6 |
| | 70 | 1500 | 9 | 438 | 39.6 |

TABLE 4
2½″ Killion Extruder 24:1 barrier screw Saxton Mixer, 18″ wide die
Temperature settings 355° F. 365° F. 375° F., die 375° F.

| | | | | | rate |
|---|---|---|---|---|---|
| | speed | pressure | current | melt T | (lb/h) |
| product | rpm | psi | amps | ° F. | (ave of 3) |
| Polymer of Example 4 | 30 | 1600 | 42 | 402 | 76.8 |
| | 50 | 1600 | 43 | 424 | 120.0 |

### Example 5

(Two Step)

22.75 pts of MDI, 72.27 pts of PTMEG (2000 Daltons) and 0.004 pts of stannous octoate were blended and reacted by vigorous stirring in a 500 ml steel beaker at 200° C. for 2 minutes. 4.97 pts of 1,4-butanediol was then quickly added to this partially reacted prepolymer and stirring continued for additional 2 minutes. The polymer melt was poured to a teflon coated pan and cured for 2 hours at 105° C. The MFI index of this polymer was found to be 4.4 measured at 200° C. under 3800 gm load. The weight average Mw GPC molecular weight was 229956 and number average Mn molecular weight was 66630 indicating high molecular weight product. The crystallinity was deter mined by DSC and shown in FIG. 6 below. Integrated peaks at 8° C. and 138° C. indicate the material is sufficiently crystalline to be considered non-tacky for membrane extrusion purposes.

While in accordance with the Patent Statutes the best mode and preferred embodiment have been set forth, the scope of the invention is not limited thereto but rather by the scope of the attached claims.

What is claimed is:

1. A thermoplastic polyurethane composition, comprising:
the reaction product of a polyether intermediate having at least a tetramethylene oxide repeat unit, and optionally a repeat unit derived from propylene oxide or from propylene oxide and ethylene oxide; a diisocyanate; and a chain extender comprising ethylene glycol, butane diol, hexane diol, dipropylene diol, ethoxylated hydroquinone, or cyclohexylydiene diol, or combinations thereof;
said composition having a water vapor transmission of at least 1,500 grams per square meter per 24 hours at atmospheric pressure and 38° C., and 100% relative humidity at a thickness of 1 to 4 mils.

2. A thermoplastic polyurethane composition according to claim 1, wherein said polyether intermediate has a number average molecular weight of from about 500 to about 4,000, wherein said diisocyanate has the formula R(NCO)₂ wherein R is an aliphatic, an aromatic, an cycloaliphatic, or combinations thereof having a total of from 2 to about 20 carbon atoms, wherein said composition has a dimensional stability of less than 10% weight gain according to ASTM D-471-98, and a crystallinity of from about 3 J/g to about 10 J/g.

3. A thermoplastic polyurethane composition according to claim 2, wherein said composition has a Shore A hardness of less than 80.

4. A thermoplastic polyurethane composition according to claim 3, wherein the amount of said polyether intermediate is from about 60% to about 80% by weight, wherein the amount of said diisocyanate is from about 20% to about 30% by weight, and wherein the amount of said chain extender is from about 1% to about 10% by weight based upon the total weight of said polyether intermediate, said diisocyanate, and said chain extender, and wherein said composition has a Tg of less than about minus 30° C.

5. A thermoplastic polyurethane composition according to claim 4, wherein said molecular weight of said polyether intermediate is from about 1,000 to about 2,500, wherein said dimensional stability is about 5% or less, and wherein said water vapor transmission is from about 1,500 to about 2,500.

6. A thermoplastic polyurethane composition according to claim 5, wherein said diisocyanate is diphenyl methane diisocyanate (MDI), wherein said diol is butane diol, wherein said thermoplastic polyurethane has a number average molecular weight of from about 50,000 to about 100,000, wherein said Tg is less than about minus 40° C., and wherein said Shore A hardness is from about 68 to about 78.

7. A thermoplastic polyurethane composition according to claim 1, wherein said composition is in the form of a sheet, said sheet being substantially free of perforations.

8. A thermoplastic polyurethane composition according to claim 4, wherein said composition is in the form of a sheet, and wherein said sheet has less than 0.5% of perforated area.

9. A thermoplastic polyurethane composition according to claim 6, wherein said composition is in the form of a sheet, and wherein said sheet has less than 0.01% of perforated area.

10. A thermoplastic polyurethane composition according to claim 1, wherein said composition is a building wrap, a roofing membrane, a wound dressing, a waterproof textile, or an elastic fiber.

11. A thermoplastic polyurethane composition according to claim 4, wherein said composition is a building wrap, a roofing membrane, a wound dressing, a waterproof textile, or an elastic fiber.

12. A thermoplastic polyurethane composition according to claim 6, wherein said composition is a building wrap, a roofing membrane, a wound dressing, a waterproof textile, or an elastic fiber.

13. A thermoplastic polyurethane composition according to claim 8, wherein said composition is a building wrap, a roofing membrane, a wound dressing, a waterproof textile, or an elastic fiber.

14. A thermoplastic polyurethane, comprising:
a polymer having repeat units derived from tetrahydrofuran, a chain extender, and a diisocyanate, wherein said chain extender comprises ethylene glycol, butane diol, hexane diol, dipropylene diol, ethoxylated hydroquinone, or cyclohexylydiene diol, or combinations thereof, wherein said diisocyanate has the formula R(NCO)₂ wherein R is an aliphatic, an aromatic, an cycloaliphatic, or combinations thereof having a total of from 2 to about 20 carbon atoms, wherein said polymer has a crystallinity of from about 3 J/g to about 10 J/g and a Tg of less than about minus 30° C.

15. A thermoplastic polyurethane according to claim 14, wherein the number average molecular weight of said thermoplastic polyurethane is from about 10,000 to about 150,000, wherein said thermoplastic urethane has a dimensional stability of less than about 5% weight gain according to ASTM D-471-98 and a vapor transmission of at least 1,500 grams per square meter at 38° C. and 100% relative humidity over a 24 hours period at a thickness from 1 to 4 mils.

16. A thermoplastic polyurethane according to claim 15, wherein said polymer has a polyether intermediate derived said tetrahydrofuran, wherein said polyether intermediate has a number average molecular weight of from about 1,000 to about 2,500, wherein said thermoplastic polyurethane polymer has a number average molecular weight of from about 50,000 to about 100,000, a Shore A hardness of from about 70 to about 75, and a dimensional stability of less than about 1.5% weight gain.

17. A thermoplastic polyurethane according to claim 16, wherein said diisocyanate is MDI, wherein said chain extender is butane diol or dipropylene glycol or combinations thereof, wherein said Tg is from about minus 40° C. to about minus 75° C., and wherein said water vapor transmission is from about 1,700 to about 2,000.

18. A thermoplastic polyurethane according to claim 16, wherein said polyurethane is in the form of a sheet, and wherein said sheet has less than 0.1% of perforated area.

19. A thermoplastic polyurethane according to claim 14, wherein said polyurethane is a building wrap, a roofing membrane, a wound dressing, a waterproof textile, or an elastic fiber.

20. A thermoplastic polyurethane according to claim 17, wherein said polyurethane is a building wrap, a roofing membrane, a wound dressing, a waterproof textile, or an elastic fiber.

21. A process for forming a thermoplastic polyurethane, comprising the steps of:
reacting a polyether intermediate comprising a tetramethylene oxide repeat unit, and optionally a repeat unit derived from propylene oxide or a mixture of propylene oxide and ethylene oxide; a diisocyanate; and a chain extender comprising ethylene glycol, butane diol, hexane diol, dipropylene diol, ethoxylated hydroquinone, or cyclohexylydiene diol, or combinations thereof, and
forming a solid sheet, said thermoplastic polyurethane having a Shore A hardness of less than 80.

22. A process according to claim 21, wherein all of said components are reacted in a single step, wherein the number average molecular weight of said polyether intermediate is from about 500 to about 4,000, wherein the number average molecular weight of said thermoplastic polyurethane is from about 10,000 to about 150,000, wherein said diisocyanate has the formula R(NCO)₂ wherein R is an aliphatic, an aromatic, an cycloaliphatic, or combinations thereof having a total of from 2 to about 20 carbon atoms, wherein said thermoplastic polyurethane has a water vapor transmission at a 1 to 4 mil thickness at 38° C. and 100% humidity of at least 1,500 grams per square meter per 24 hours, and wherein said thermoplastic polyurethane has a Tg of less than about minus 40° C.

23. A process according to claim 22, wherein said diisocyanate is MDI, wherein said diol is butane diol or dipropylene diol, or combinations thereof, wherein said Shore A hardness is from about 68 to about 78, and wherein said thermoplastic polyurethane has a dimensional stability of less than 3% weight gain according to ASTM D-471-98.

24. A process according to claim 23, wherein the number average molecular weight of said polyether intermediate is from about 1,500 to about 2,200, wherein the number average molecular weight of said thermoplastic polyurethane is from about 50,000 to about 100,000, wherein said water vapor rate transmission is from about 1,700 to about 2,000, wherein said Tg is from about minus 40° C. to about minus 75° C., and wherein said thermoplastic polyurethane has a crystallinity of from about 4 J/g to about 8 J/g.

25. A process according to claim 21, wherein initially said polyether intermediate is reacted with an excess of a diisocyanate to form a prepolymer solution, and subsequently reacting said prepolymer solution with said chain extender to form said thermoplastic polyurethane.

26. A process according to claim 25, wherein said thermoplastic polyurethane has a water vapor transmission at a 1 to 4 mil thickness at 38° C. and 100% humidity of at least 1,500 grams per'square meter per 24 hours, and wherein said thermoplastic polyurethane has a Tg of less than about minus 40° C.

27. A process according to claim 26, wherein said diisocyanate is MDI, wherein said diol is butane diol or dipropylene diol, or combinations thereof, wherein said Shore A hardness is from about 68 to about 78, and wherein said thermoplastic polyurethane has a dimensional stability of less than 3% weight gain according to ASTM D-471-98.

28. A process according to claim 27, wherein the number average molecular weight of said polyether intermediate is from about 1,500 to about 2,200, wherein the number average molecular weight of said thermoplastic polyurethane is from about 50,000 to about 100,000, wherein said water vapor rate transmission is from about 1,700 to about 2,000, wherein said Tg is from about minus 40° C. to about minus 75° C., and wherein said thermoplastic polyurethane has a crystallinity of from about 4 J/g to about 8 J/g.
